(19) United States
(12) Patent Application Publication
(10) Pub. No.: US 2005/0109835 A1
(43) Pub. Date: May 26, 2005

(54) User self-authentication system and method for remote credit card verification

(76) Inventors: Brian L. Jacoby, Carmel, IN (US); Robert E. Reinke, Indianapolis, IN (US)

Correspondence Address: BAKER & DANIELS, 300 NORTH MERIDIAN STREET, SUITE 2700, INDIANAPOLIS, IN, 46204-1782, US

(21) Appl. No.: 10/997,168

(22) Filed: Nov. 24, 2004

Related U.S. Application Data
(60) Provisional application No. 60/525,454, filed on Nov. 26, 2003.

(51) Int. Cl. G06F 17/60

(52) U.S. Cl. 235/379

(57) ABSTRACT

The present invention involves an account transaction authentication system and method which provides user verification of transactions. The method for authenticating an account transaction includes associating an account with a device; creating a confirmation message on the device for a transaction; and authenticating the transaction if a confirmation message is received from the device. The method may use an authenticating device in the form of a personal computer connected to a communications network, a mobile telephone, a wireless personal digital assistant, and may also include a biometric device. Authenticating may involve encryption keys for validation. The computer associates an account with a user account device, and also communicates with the financial institution and to determine that the account transaction requires authentication. The computer activates the user account device to enable the account user to authenticate the account transaction.

### BACKGROUND OF THE INVENTION

1. Field of the Invention

The invention relates to credit card authentication systems and methods. More specifically, the field of the invention is that of individual transaction software for verification and authentication of the user of a credit card.

2. Description of the Related Art

Credit cards are used extensively as a payment system in commerce. An individual presents a credit card to a vendor so that payment for a transaction is debited against the individual's account. The vendor authenticates the user of the card, typically by checking a form of identification like a driver's license. The vendor also verifies that the credit card account exists and has sufficient credit for the presented transaction by contacting the credit card company, either telephonically or over other electronic communication.

The authentication and verification of credit cards has evolved over the years to include remote transactions. For example, an individual placing an order over a telephone may supply credit card information, such as the billing address of the credit card account, to authenticate the use of the credit card. The vendor in this remote transaction then verifies the account and credit limit as before, but additionally authenticates the use of the credit card by matching the supplied billing address information with the charge card company.

With the advent of electronic commerce, more credit cards are used remotely. However, such transactions have greater risks in terms of authentication because electronic information is more easily accessed and transmitted. Many experts in this field believe significant numbers of credit card users do not participate in on-line commerce over the Internet for these reasons. Some systems have been developed that use public or private key cryptography to provide a high level of security. However reliable these cryptography systems are, many individuals find such systems overly complicated and difficult to understand, impeding the use of such secure systems.

### SUMMARY OF THE INVENTION

The present invention is a credit card authentication system and method which uses an association between a credit card account and a discrete physical device to provide authentication of the user of the credit card. For each credit card operating in accordance with the present invention, the credit card company has an association between the credit card account and a discrete device which is in communication with the credit card company. For example, a credit card user's computer may have software on her computer that allows the user to authenticate a particular use of the credit card account. Similarly, with the present invention a credit card account may be associated with the user's telephone number so that a telephone call can authenticate the transaction.

In addition to predicating the approval of the use of a credit card with a message from an approved source, the approval process may also be combined with a higher level of security. For example, a password or an encryption key may be required from the approved source to complete the transaction. Further, a biometric signature might also be required. A personal computer (“PC”), a personal data assistant (“PDA”), or a mobile or cellular telephone may be equipped with a biometric device (finger print reader, retina scanner, voice identifier, etc.) so that the approved source device may transmit a suitable biometric signature as part of the approval.

The present invention, in one form, relates to a method for authenticating an account transaction comprising the steps of: associating an account with a device; sending a confirmation message to the device when a transaction is presented; and authenticating the transaction when a confirmation message is received from the device. The device may be one of a personal computer connected to a communications network; a mobile telephone; a wireless personal digital assistant; a biometric device; a pager, a bar code reader; or a magnetic strip reader. The authenticating step may include using encryption keys to validate a confirmation message.

The present invention, in another form, is a computer for authenticating account transactions with the account user wherein account transaction information is received from a financial institution. The computer comprises: a device for associating an account with a user account device designated by the account user (the associating device also adapted to enable the user account device to communicate over the network); a device for communicating with the financial institution and determining that the account transaction requires authentication; and a device for activating the user account device to enable the account user to authenticate the account transaction. The activating device uses encryption keys to activate the user account device. The activating device also may include a connection which is directly connectable with the account device. The activating device may include one of a plug-in card and a plug-in chip.

Further aspects of the present invention involve a method of authenticating an account transaction by associating an account with a device; sending a confirmation message to the device when a transaction is presented; and authenticating the transaction when a confirmation message is received from the device. The sending step may include sending an encrypted message across a network, sending an encrypted radio transmission, or sending an encrypted message over a telecommunications line or a power line.

Another aspect of the invention relates to a machine-readable program storage device for storing encoded instructions for a method of authenticating an account transaction according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of the transaction processing system of the present invention.

FIG. 2 is a schematic diagrammatic view of a second embodiment of the present invention relating to a separate authentication service.

FIG. 3 is a schematic diagrammatic view of a third embodiment of the present invention relating to a separate authentication service.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method of operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output. Objects may also be invoked recursively, allowing for multiple applications of an objects methods until a condition is satisfied. Such recursive techniques may be the most efficient way to programmatically achieve a desired result.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an extensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces.

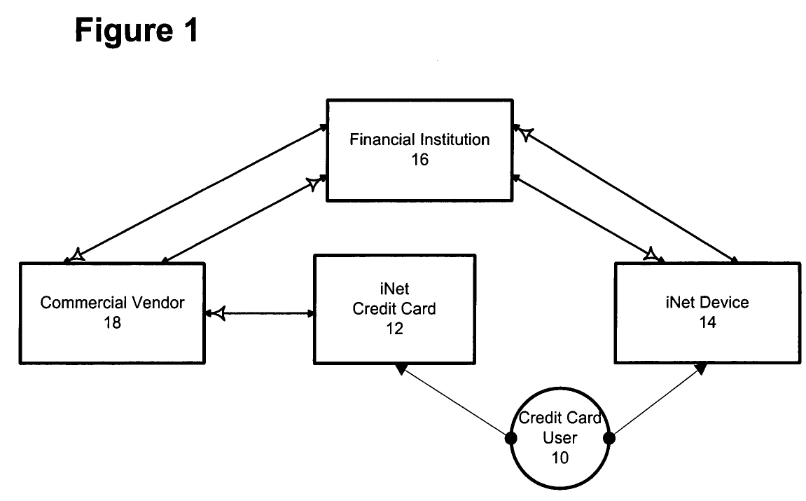

FIG. 1 shows a schematic representation of a system employing the present invention. In the following discussion, a credit card that is enabled with the authentication processing of the present invention shall be referred to as an “iNet” credit card, and other items associated with implementing this invention may also be described with the adjective “iNet” although general purpose devices and items may be used to implement the present invention. In addition to using the present invention with a credit card, the present invention is also applicable with debit cards, club cards, identification cards, and other suitable uses. As shown in FIG. 1, Credit card user 10 uses both credit card 12 and iNet device 14 in setting up an account with financial institution 16. iNet credit card 12 may be supplied by user 10 or financial institution 16, and to enable credit card 12 to function as an iNet credit card, user 10 or financial institution 16 associates an account with iNet device 14. Upon user 10 presenting iNet credit card 12 to commercial vendor 18, the proposed transaction is transmitted to financial institution 16 for approval. As financial institution 16 recognizes an association between credit card 12 and a particular iNet account, financial institution 16 sends a confirmation message to iNet device 14. The confirmation message may have some information about the transaction which was presented to commercial vendor 18, for example the amount of the transaction and an identification of commercial vendor 18. User 10 would need to respond affirmatively on iNet device 14 to authenticate the transaction with a confirmation message to financial institution 16. iNet device 14 may be a personal computer, a cell phone, a PDA, or other device that may directly or indirectly communicate a confirmation message. Alternatively, credit card user 10 may use iNet device 14 prior to a purchasing event to provide a prior approval to a transaction. Such a prior approval may be made moments or days before the transaction is presented to commercial vendor 18. In this alternative method, credit card user 10 activates iNet device 14 to pre-authorize a purchase, and then performs a normal purchase event with commercial vendor 18. Commercial vendor 18 contacts financial institution 16, which authorizes the transaction because of the prior approval.

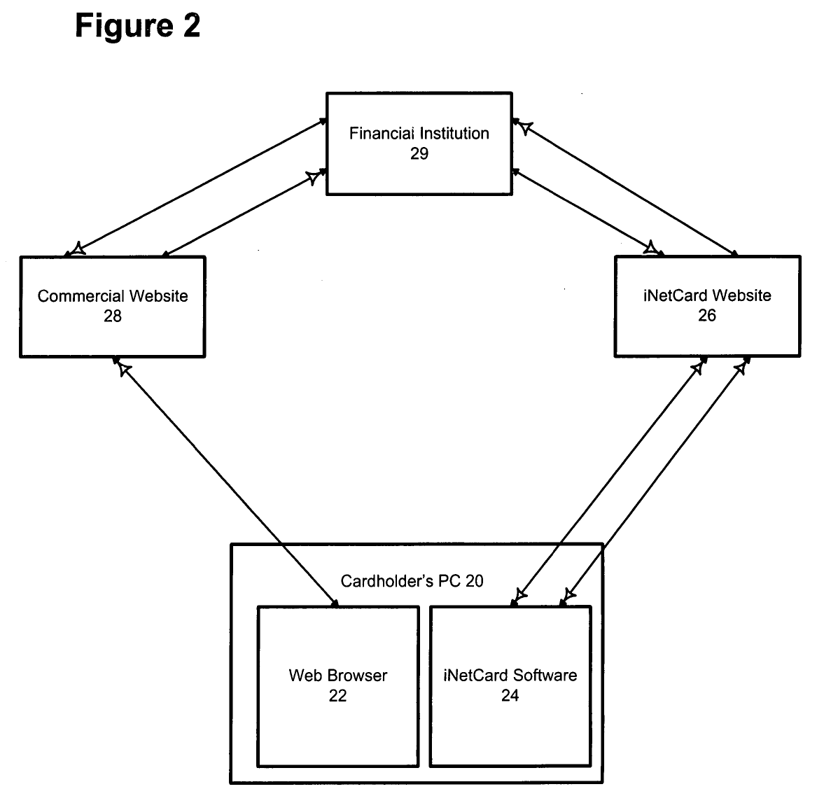

Another, more detailed explanation of the process of the present invention relates to the embodiment of FIG. 2. The individual with the iNet credit card has cardholder's PC 20 which is configured for one exemplary use of an iNet credit card with web browser 22 and iNetcard software 24. At some point in time, iNetcard software 24 is initialized and configured to communicate over a network connection, for example an internet connection using the world wide web protocol, with iNetcard website 26. Although iNetcard website 26 only needs to have the location information of iNetcard software 24 to complete the transaction described in greater detail below, to enhance security iNetcard software 24 may be configured to initiate contact and validate identity whenever cardholder's PC 20 is powered on or connected to a suitable network connection. Cardholder's PC 20 may also connect to commercial web site 28 through conventional communication protocols to conduct an on line commercial transaction using an iNet credit card. As described in greater detail below, to process such an iNet credit card transaction, commercial web site communicates with financial institution 29 either over a similar network connection or other communications system.

The process of the commercial transaction over the exemplary system of FIG. 2 first involves iNetcard software 24 connecting to iNetcard website 26 and validating its identity. When the user of cardholder's PC 20 is ready to conclude a transaction on commercial web site 28, that user supplies the identifying information relating to the iNet credit card. Commercial website 28 then sends a message to financial institution 29 requesting a verification of the transaction. Once financial institution 29 verifies the identification of the iNet credit card, financial institution 29 contacts iNetcard website 26 and requests validation of the transaction. iNetcard website 26 then contacts iNetcard software 24 and requests user confirmation of the transaction, for example by a pop up window on cardholder's PC 20 displaying the financial details of the transaction and an “OK” button. Alternatively, cardholder's PC 20 and iNetcard software 24 may be configured to require a biometric approval of the transaction with a finger print reader, a retinal scanner, voice recognition equipment, etc. iNetcard website 26 will, based on the responsive message from iNetcard software 24, send a message to financial institution 29 either approving or denying the transaction, which will be relayed to commercial website 26 to approve or deny the use of the iNet credit card. Alternatively, cardholder's PC 20 may use iNetCard software 24 to provide prior approval to iNetCard website 26 for a specific transaction prior to a purchasing event. Such a prior approval may be made moments or days before the transaction is presented to commercial website 28. In this alternative method, cardholder's PC 20 activates iNetCard software 24 to pre-authorize a purchase on iNetCard website 26, and then performs a normal purchase event with commercial website 28. Commercial website 28 contacts financial institution 29, which authorizes the transaction because of the prior approval.

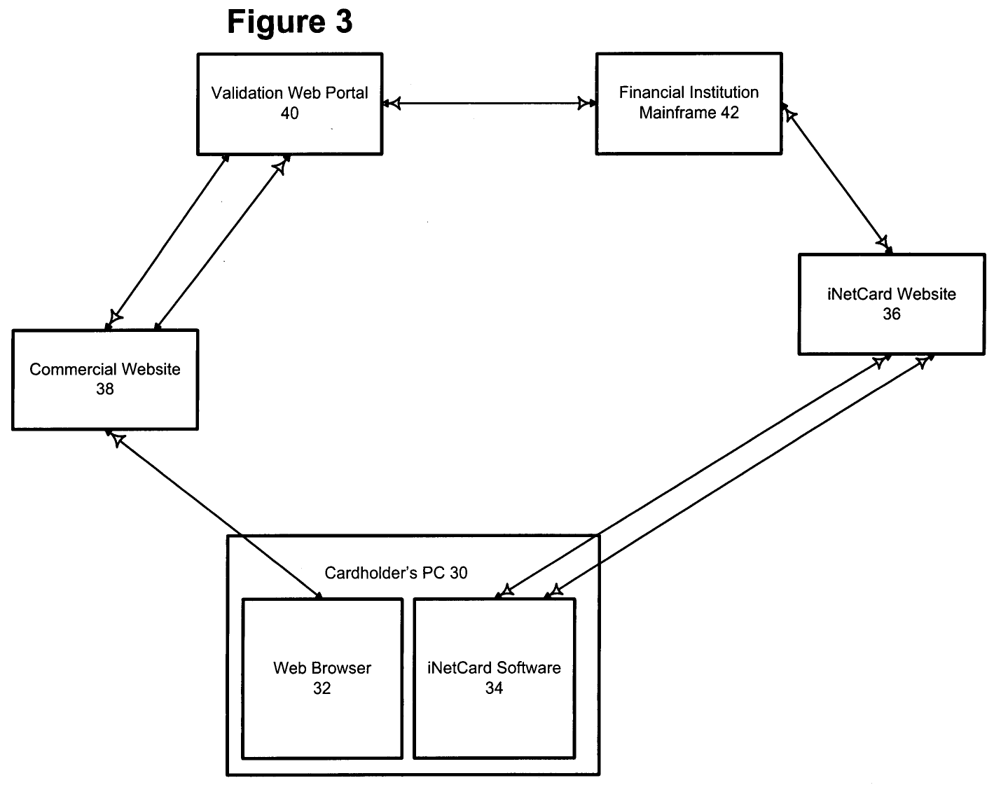

FIG. 3 provides a more detailed explanation of an embodiment of the present invention using some specific technologies and procedures, which should not be construed as a limitation of the invention. Rather, this embodiment is provided as an example of one implementation of the present invention. Cardholder PC 30, web browser 32, iNetcard software 34, iNetcard website 36, and commercial web site 38 serve similar functions as the similarly labeled elements of FIG. 2. In this exemplary embodiment, commercial website 38 communicates through validation web portal 40 for confirmation of the commercial transaction, and validation web portal 40 then interacts with financial institution mainframe 42 to confirm the transaction, as described in greater detail below. While the financial institution is represented by financial institution mainframe 42 as such systems are typically, although not exclusively, operated on mainframe computers, the present invention may be implemented with the financial institution's function performed by other computing systems such as super-mini computers or even personal computer based servers.

The specific process utilized in the embodiment of FIG. 3 starts with the iNet. cardholder being provided a CD-ROM (not shown) with appropriate installation software to configure cardholder's PC 30. Alternatively, such appropriate installation software may be delivered electronically via a telecommunications or network connection. Such installation software may also include public and private encryption keys to validate the particular card holder. The user activates the installation software on cardholder's PC 30 to enable operation of the inventive system, including installing the applicable keys. That user would then activate iNetcard software 34 to register with iNetcard website 36 and obtain the location information for the iNet device, in this exemplary embodiment being cardholder's PC 30. This registration process may involve an asymmetric key authentication protocol to validate the user, and machine identification and location information would then be obtained to set up symmetric keys if needed. Once installed and registered, the iNet card user may go to any commercial web site 38 and use the iNet card for a transaction. Commercial web site 38 commences a conventional transaction verification with validation web portal 40. Validation web portal 40 initiates a conventional validation of the transaction with financial institution mainframe 42 to confirm the transaction. Financial institution mainframe 42 recognizes the iNet card and communicates with iNetcard website 36 for validation, for example by private communication lines with a server (not shown) of iNetcard website 36. iNetcard website 36 initiates an encrypted communication with iNetcard software 34 to approve or deny the transaction, which is communicated back through the chain of iNetcard website 36, financial institution mainframe 42, validation web portal 40, to commercial web site 38.

The process detailed in FIG. 3 may be alternatively configured to allow for pre-approval of transactions. Cardholder's PC 30 may include iNetcard software 34 in the form of a program that is activated by a task bar icon, a pre-defined control key, a pop-up window or the like. Prior to using web browser 32 to perform a purchasing transaction on commercial web site 38, the user of cardholder's PC 30 activates iNetCard software 34 to log into iNetCard website 36 and provide pre-authorization for the transaction (e.g., by indicating a payee and an amount or limit for purchasing authorization). Once completed with the pre-authorization with iNetCard website 36, the user accesses commercial web site 38 with web browser 32 to make a purchase. Commercial web site 38 contacts validation web portal 40 for authorization, and validation web portal 40 contacts financial institution mainframe 42 for authorization. Financial institution mainframe 42 then contacts iNetCard website 36 for approval, which in the case of pre-authorization would be approved. iNetCard website 36 may then approve (or deny if appropriate) and may also notify cardholder's PC 30 via e-mail or via activation of iNetCard software 34 (if the cardholder is currently logged in). The approval or denial of the charge is communicated back through financial institution mainframe 42, validation web portal 40, to commercial website 38.

Other alternative embodiments are also possible. For example, automated teller machine (ATM) transactions may also require verification by a cell phone or pager. Even further devices may be used as the authentication device for the invention, for example in addition to cell phones and pagers, barcode readers and/or magnetic strip readers may also be used. These devices may use wireless methods, such as common radio waves or various encoding techniques with cellular telephone technologies. These devices may also use wired connections, such as encrypted signals over power or telephone lines or on a direct internet connection or with a plug-in card or chip.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method for authenticating an account transaction comprising the steps of:
associating an account with a device;
creating a confirmation message on the device for a transaction; and
authenticating the transaction if a confirmation message is received from the device.

2. The method of claim 1 wherein the device is a personal computer connected to a communications network.

3. The method of claim 1 wherein the device is a mobile telephone.

4. The method of claim 1 wherein the device is a wireless personal digital assistant.

5. The method of claim 1 wherein the device includes a biometric device.

6. The method of claim 1 wherein the device includes a pager.

7. The method of claim 1 wherein the device includes a bar code reader.

8. The method of claim 1 wherein the device includes a magnetic strip reader.

9. The method of claim 1 wherein the authenticating step includes using encryption keys to validate a confirmation message.

10. The method of claim 1 wherein the step of creating a confirmation message on the device occurs prior to the transaction.

11. The method of claim 1 wherein the step of creating a confirmation message is activated by a message requesting approval of the transaction.

12. A computer for authenticating account transactions over a network for an account user having an account with a financial institution, said computer comprising:
means for associating the account with a user device designated by the account user, said associating means also adapted to enable the user device to communicate over the network;
means for activating the user device to enable the account user to authenticate the account transaction; and
means for communicating with the financial institution and authorizing an account transaction.

13. The computer of claim 12 wherein said activating means uses encryption keys to activate the user account device.

14. The computer of claim 12 wherein said activating means includes a connection which is directly connectable with the account device.

15. The computer of claim 12 wherein said activating means includes one of a plug-in card and a plug-in chip.

16. In computer, a method of authenticating an account transaction, said method comprising the steps of:
associating an account with a device;
creating a confirmation message on the device for a transaction; and
authenticating the transaction if the confirmation message is received from the device.

17. The method of claim 16 wherein said sending step includes sending an encrypted message across a network.

18. The method of claim 16 wherein said sending step includes sending an encrypted radio transmission.

19. The method of claim 16 wherein said sending step includes sending an encrypted message over a telecommunications line.

20. The method of claim 16 wherein said sending step includes sending an encrypted message over a power line.

21. A machine-readable program storage device for storing encoded instructions for a method of authenticating an account transaction, said method comprising the steps of:
associating an account with a device;
creating a confirmation message on the device when a transaction is presented; and
authenticating the transaction when a confirmation message is received from the device.
